(19) United States
(12) Patent Application Publication
(10) Pub. No.: US 2002/0136377 A1
(43) Pub. Date: Sep. 26, 2002

(54) System and method for providing advertisement contingent charge options to a user of a telephony device

(76) Inventors: Brett B. Stewart, Austin, TX (US); James W. Thompson, Austin, TX (US)

Correspondence Address: Jeffrey C. Hood, Conley, Rose, & Tayon, P.C., P.O. Box 398, Austin, TX, 78767, US

(21) Appl. No.: 09/816,691

(22) Filed: Mar. 22, 2001

(51) Int. Cl. H04M 15/00

(52) U.S. Cl. 379/114.13; 379/114.05; 379/114.1

(57) ABSTRACT

System and method for providing advertisements to a telephony device. The advertisements are presented by an advertisement server which stores the advertisements, manages their presentation through the device, and provides for reduction or elimination of charges for telecommunication services delivered through the device. The advertisements may be presented to the user upon activation of the device and may include a recorded message promoting products, stores, sales, or public services, after which the user places the telephone call at reduced or no charge. Alternately, when the user initiates a telephone connection to place a call, a charge option message is presented providing the user with an option to listen to an advertisement before placing the call. If the user declines the option, the call is placed at normal cost, otherwise, an advertisement is presented to the user, after which the user places the call at a reduced or no cost.

### BACKGROUND OF THE INVENTION

1. Field of the Invention

This invention relates to telecommunications and Internet telephony, and, more particularly, to providing advertisement-contingent charge options to a telephony device, wherein charges paid by a user for use of the telephony device are dependent on a user's choice of whether to receive advertising on the telephony device.

2. Description of the Relevant Art

Primary telephone services are provided at many public facilities such as hotels, motels, apartments, airports, entertainment complexes, shopping malls, offices, and even aircraft, generally in the form of pay-phones or as a billable service. Such enterprises often utilize a private branch exchange (PBX), a private telephone network used within an enterprise. Users of the PBX share a certain number of outside lines for placing telephone calls external to the PBX. Most medium-sized and larger companies use a PBX because it's much less expensive than connecting an external telephone line to every telephone in the organization. In addition, it is easier to call someone within a PBX because the number dialed is typically just 3 or 4 digits. A new variation on the PBX theme is the central office exchange service, or centrex, which is a PBX with all switching occurring at a local telephone office instead of at the company's premises. Typically, the telephone company owns and manages all the communications equipment necessary to implement the PBX and then sells various services to the company.

Increasingly, IP Telephony is being used for telecommunication services. IP Telephony is a category of hardware and software that enables people to use the Internet as the transmission medium for telephone calls. For users who have free, or fixed-price Internet access, Internet telephony software essentially provides free telephone calls anywhere in the world. To date, however, Internet telephony does not offer the same quality of telephone service as direct telephone connections, although this is expected to change in the near future as broadband network capabilities become ubiquitous. Note, as used herein, the terms “telephony device” “telephone” or “phone” may refer to any telephony device used to place or receive a telephone call.

Generally, telephone services are provided by businesses for a fee. For example, hotels typically charge users per call fees for both local and long distance telephone calls. In a similar manner, passengers are required to pay for the use of telephones in airplanes. Public pay telephones are ubiquitous and typically require a payment at the time of service, either in the form of a credit card or calling card, or by depositing coins in the pay telephone. Home telephone services also involve various charges, ranging from fixed rate monthly fees to metered use billing to various long distance calling charges. There is currently no known method or system whereby advertisements may be delivered to users of the telephone services to reduce or eliminate the fees associated with the use of the services. Therefore, an improved system and method for providing telephone services are desired.

### SUMMARY OF THE INVENTION

The present invention comprises various embodiments of a system and method for providing advertisements and advertisement-based charging options to a telephony device as disclosed herein. More particularly, one embodiment of the present invention comprises a system and method for providing different charging options to a user of a telephone dependent upon the user's acceptance of advertising presented on the telephone.

A telephony system is described whereby advertisements may be selectively provided to a telephony device. In one embodiment, the advertisements may be presented by an advertisement server. The advertisement server may be coupled to a private branch exchange (PBX), which in turn may couple to a plurality of telephony devices. In one embodiment, the advertisement server may include an advertisement management program which is operable to manage the presentation of advertisements through the telephony device. The advertisement server may provide for reduction or elimination of charges for telecommunication services delivered through the telephony device based upon the user's acceptance of advertising presented on the telephony device. The advertisements may be stored on the advertisement server and presented to the user upon activation of the telephony device and acceptance by the user.

In one embodiment, a user may optionally subscribe to the advertisement/discount service. For example, the service may be provided by a telephone company to users wishing to reduce or eliminate their monthly local or long-distance telephone bills. In another embodiment, the user is presented with an option to receive the advertising for reduced charges when the user begins placing a telephone call.

In one embodiment, the method operates as follows. First, the user initiates a telephone connection. This may be as simple as picking up a receiver on a standard telephone, or may comprise establishing a dial tone with a computer using an Internet Telephony program. Once the user has established a connection, in one embodiment the system may present the user with one or more options to either 1) place a call at normal charges, or 2) listen to (and/or view) advertising, after which a call may be placed at reduced charges. If the user has previously subscribed to a reduced fee service, then the user may not be presented with the option, because the presentation of advertising and corresponding reduction in fees is automatic. If the user selects the reduced fee option to receive advertising, or if the user has previously subscribed to this feature, then an advertisement may be presented to the user. In one embodiment, the advertisement may be presented to the user by an advertisement server. The advertisement may include a recorded audio message promoting products, brands, stores, sales, or public services. In another embodiment, the telephone may be a video telephone (e.g., a computer), and the advertisement may include video as well as audio messages. After the user has been presented with the advertisement, the user may place the telephone call. Any charges associated with the telephone call may be reduced or eliminated by the advertisement server in response to the user receiving the advertisement.

This method may be used by any enterprise which hosts pay telephones, such as hotels, airports, office buildings, cruise ships, hospitals, convenience stores, or any other place where telecommunication services may be used for a fee, including homes.

### BRIEF DESCRIPTION OF THE DRAWINGS

Other advantages and details of the invention will become apparent upon reading the following detailed description and upon reference to the accompanying drawings in which:

FIG. 1 is a block diagram of a two-wire analog telephone line communications channel routed from the PSTN through a PBX with an advertising server, according to one embodiment.

FIG. 2 is a flowchart of a process for providing advertisements to a user of a telephony device, according to one embodiment.

FIG. 3 is a flowchart of a process for providing charge options to a user of a telephony device, according to one embodiment.

While the invention is susceptible to various modifications and alternative forms, specific embodiments thereof are shown by way of example in the drawings and will herein be described in detail. It should be understood, however, that the drawings and detailed description thereto are not intended to limit the invention to the particular form disclosed, but on the contrary, the intention is to cover all modifications, equivalents and alternatives falling within the spirit and scope of the present invention as defined by the appended claims.

### DETAILED DESCRIPTION OF THE EMBODIMENTS

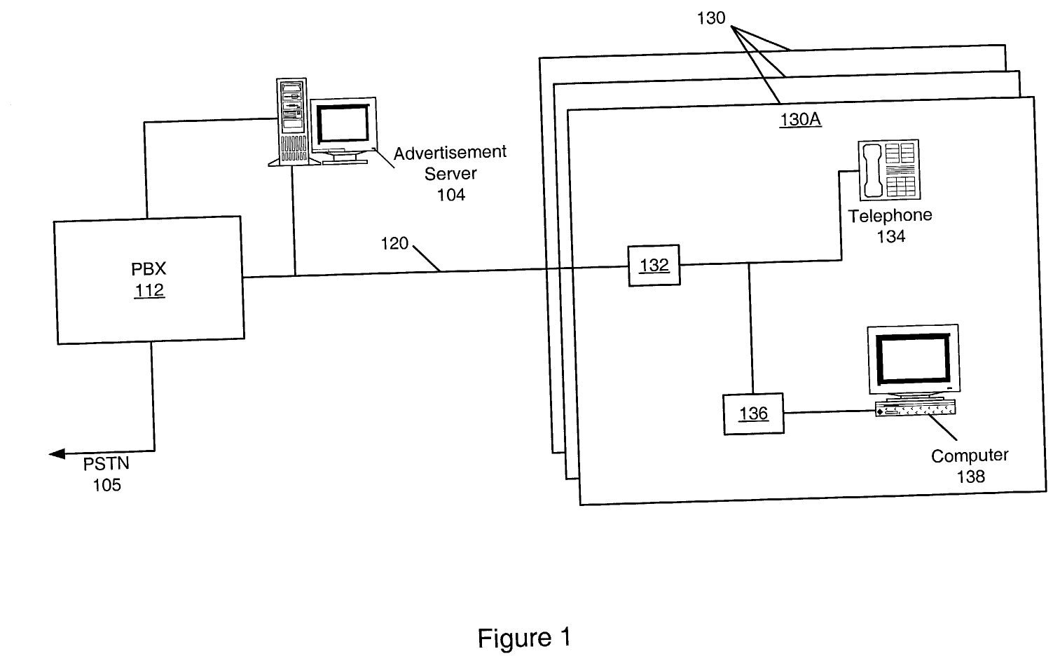

FIG. 1: A Telephony System With Advertisement Server

FIG. 1 illustrates a telephony system according to one embodiment of the invention. FIG. 1 illustrates an exemplary telephony system, and it is noted that the present invention may be used in or implemented by any of various systems, as desired.

As FIG. 1 shows, public switched telephone network (PSTN) lines 105 may be provided from a central office to a PBX 112 in the general vicinity of an end-user. An advertisement server 104 may be coupled to PBX 112. The PBX 112 may be a conventional private branch exchange (analog or digital), a telephony server, or other type of telephony hosting device. The PBX 112 and/or the advertisement server 104 may be coupled to one or more or a plurality of user locations 130, including a particular end user location 130A. Each of the user locations 130 may correspond to rooms in a hotel, public pay telephones in an airport, telephones in an airplane, or other telephone locations. The user locations 130 may also correspond to homes which are serviced by a central office.

Each location 130 may receive telephone services through local PBX 112. In one embodiment, the advertisement server 104 may be coupled to the telephony devices directly, rather than through the PBX. In one embodiment, the PBX 112 may include the functionality of the advertisement server 104; i.e., the advertisement server may be a component of the PBX, rather than a separate computer system. For example, a single telephony server may perform both the PBX function and the advertisement server function.

Telephone 134 and computer system 138 are shown at the user location 130A for use as telephony devices. Thus the telephone 134 may be used as the telephony device, and/or the computer system 138 may be used as the telephony device. As used herein, the terms “telephony device” “telephone” or “phone” may refer to any telephony device used to place or receive a telephone call, including standard POTS telephones, digital telephones, wireless telephones, PDA's (personal digital assistants), and Internet telephony devices, including computers configured as telephones.

In one embodiment, the advertisement server 104 may be operable to manage the presentation of advertisements through a telephony device, and to provide for reduction or elimination of charges for telecommunication services delivered through the telephony device. The advertisements may be stored on the advertisement server 104 and presented to the user upon activation of the telephony device. In one embodiment, the advertisement server 104 may include an advertisement management program which is operable to manage the storage of advertisements on the advertisement server 104, and to manage the presentation of advertisements to the user through the telephony device.

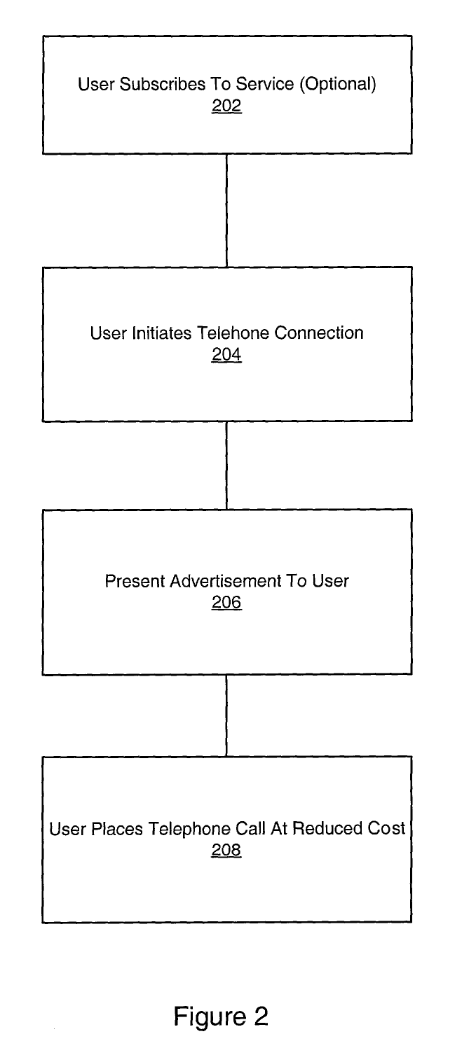

FIG. 2: Process For Providing Advertisements to a User Of A Telephony Device

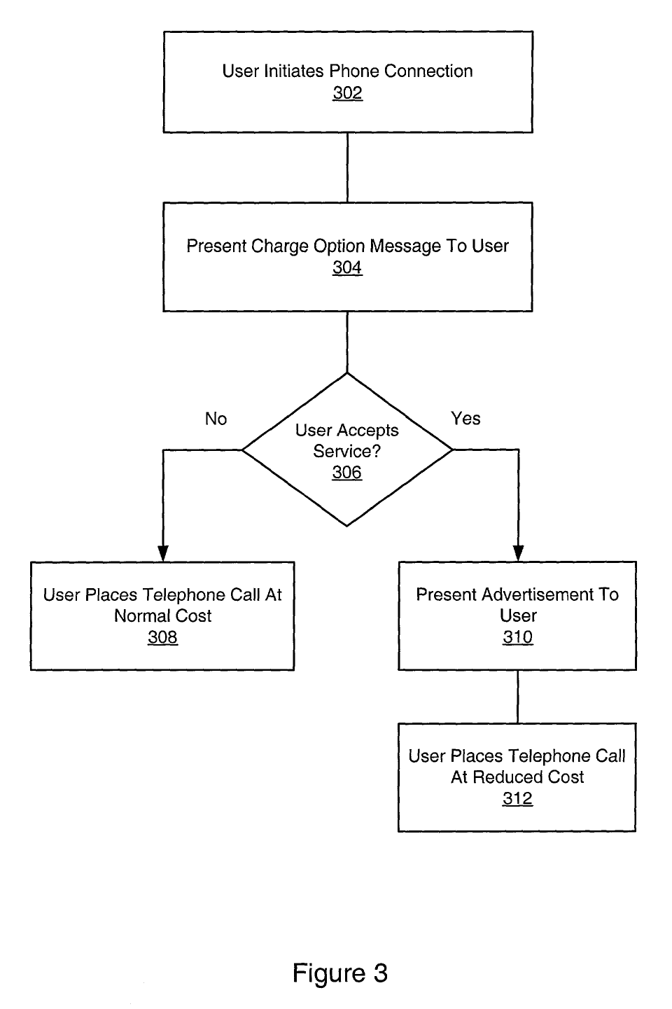

FIG. 2 is a flowchart of a process for providing advertisements to a user of a telephony device, according to one embodiment. As FIG. 2 shows, in 202, a user may optionally subscribe to the service. For example, the service may be provided by a telephone company to users wishing to reduce or eliminate their monthly local or long-distance telephone bills, and users may subscribe to this service. As another example, a user registering for a hotel room may opt for this service during check-in. Note that such a subscription is optional. In one embodiment the service may be provided automatically, without need of user subscription. In another embodiment, discussed with reference to FIG. 3, the system may present the advertisement/reduce charge option to the user before each telephone call.

In 204, the user initiates a telephone connection. This may involve picking up a receiver on a standard telephone, or beginning to place a call on a wireless telephone (e.g., a cellular telephone), or establishing a dial tone with a computer using an Internet Telephony program, or other methods for beginning voice communications.

In 206, an advertisement may be presented to the user of the telephone after the user initiates a telephone connection. The advertisement may be presented to the user due to the user having previously subscribed to the service. Alternatively, the advertisement may be presented automatically to the user without any subscription requirement. In one embodiment, the advertisement may be presented to the user by the advertisement server 104.

The advertisement is preferably presented to the user through the telephony device. Thus the user will hear (and/or see) the advertisement on the telephony device prior to making the call. Alternatively, the advertisement may be presented through a mechanism other than the telephony device being used to make the call. For example, in a hotel system, the user may be required to receive the advertisements displayed on a designated channel of the television system in the room.

In one embodiment, the advertisement may include a recorded audio message promoting products, brands, stores, sales, or public services. In another embodiment, the telephone may be a video telephone, and the advertisement may include an audiovisual message. The presented advertisement may preferably be between 15 seconds and one minute in duration, although advertisements of any length may be used.

The advertisements may be based on the geographic location of the user or of the telephony device being used by the user. Thus, if the user is staying at a certain hotel, the advertisements may related to restaurants and stores close by. The advertisements may also be based on known demographic information of the user, such as the user's preferences, buying habits, etc.

In 208, after the user has been presented with the advertisement, the user may proceed to place the telephone call. Any charges associated with the telephone call may be reduced or eliminated. For example, the advertisement server 104 or a separate billing server may track the telephone usage and use a reduced rate due to the presentation of advertising.

FIG. 3: Process For Providing Charge Options to a User Of A Telephony Device

In another embodiment, the user may be given the choice of whether to use the advertisement/discount service when initiating a telephone call. FIG. 3 is a flowchart of a process for providing charge options to a user of a telephony device, according to one embodiment.

As FIG. 3 shows, in 302, the user initiates a telephone connection to place a telephone call. As described above, this may involve picking up a receiver on a standard telephone, or beginning to place a call on a wireless telephone (e.g., a cellular telephone), or establishing a dial tone with a computer using an Internet Telephony program, or other methods for beginning voice communications.

In 304, a charge option message may be presented to the user. In one embodiment, the charge option message may be presented to the user by advertisement server 104 which is coupled to the telephony device 134 (or 138). The charge option message may inform the user of an option to listen to an advertisement before placing the call, after which the call may be completed at a reduced or no cost to the user.

In 306, the user may choose whether or not to accept the service. In one embodiment, the advertisement server 104 mentioned in 304 may receive user input indicating the user's choice. If the user chooses not to use the service, then in 308, the user places the telephone call at normal cost.

However, if the user chooses to accept the service, then in 310, an advertisement may be presented to the user. In one embodiment, the advertisement may be presented to the user by the advertisement server mentioned in 304 and 306. As described above, the advertisement may include a recorded audio message promoting various products, brands, stores, sales, or public services. In another embodiment, the telephone may be a video telephone, and the advertisement may include an audiovisual message. After the advertisement has been presented to the user, then in 312, the user places the telephone call at a reduced or no cost. Here the advertisement server 104, or a separate billing server, may track the user's telephone usage and use a reduced or discounted rate due to the user's acceptance of the service in step 306.

Exemplary Embodiments

In one embodiment, the present invention may be implemented in public telephones in a shopping mall. A user attempting to place a call on one of the public telephones may optionally be presented with various advertisement-based charge options. If the user selects a reduced fee option which involves receiving advertising, then the user is presented with an advertisement promoting sales at one or more of the mall stores before the call connection is completed. As discussed above, the user may choose an option to receive the advertising for reduced charges, or may have previously subscribed to this service, or the service may be automatic without a subscription. The advertisements may be geographic-based, i.e., may be based on the geographic location of the telephone within the mall. Thus the advertisements may be of stores proximate to the telephone being used. After the advertisement is presented, the call may be completed as usual, but at a reduced cost. In one embodiment, the use of the public telephone may be free of charge. In another embodiment, the user may deposit the normal fee into the public telephone before placing the call; once the advertisement has been presented, the deposited fee may be returned to the user.

In another embodiment, the telephony devices may include one or more telephones or computer systems equipped for Internet telephony at a ‘cyber café’, where Internet-connected computers may be available to the public for web browsing or other uses. For example, a user may pay a standard rate to use a computer to search or browse the web, and an additional fee to place telephone calls over the Internet. In one embodiment, the additional fee for a telephone call may be waived or reduced if the user first receives, e.g., listens to or views, an advertisement presented on the computer system.

In one embodiment, a hotel may provide the service described above as an option at check-in. If a user elects to use the service, then, for example, local or long distance calls may be preceded by advertising presented on the telephone, and then are made at reduced or no charge to the room. In one embodiment, if the user elects to use the service at check-in, then the reduced fee service may be automatic. Thus the user may not be presented with the option upon initiating each telephone call, but instead will be presented with the advertisement, after which the user may make the call at reduced or no charge. In another embodiment, if the user elects to use the service at check-in, then the reduced fee option may still be presented each time the user initiates a telephone call. If the user does not elect to use the service at check-in, then no options may be presented when the user initiates a telephone call and the call may be made at normal cost.

In one embodiment of the present invention, the system of the present invention may be implemented for telephony devices on a commercial airliner. Again, as described above, the user may receive a reduced rate for use of a telephone after listening to an advertisement. This approach may be used by any enterprise which hosts pay telephones, such as airports, office buildings, cruise ships, hospitals, convenience stores, or any other place where telecommunication services may be used for a fee, including homes.

In a further embodiment, the telephony devices may include one or more wireless telephones or cellular telephones on a cellular network, wherein the normal fees for cellular telephone use may be reduced or eliminated contingent upon the presentation of one or more advertisements to the user.

In another embodiment of the invention, the reduced fee option may be presented to the user upon the user initiating a first telephone connection. If the user selects the reduced fee option, the reduced fee service is provided (with advertisement). When the user initiates subsequent telephone connections (calls), the reduced fee service may be provided automatically due to the user's previous selection of this option, i.e., the user may be presented with the advertisement (and reduced fee) without having to select the option. If the user does not select the reduced fee option after initiating the first telephone connection, then when the user initiates subsequent telephone connections, the reduced fee option may optionally not be presented, and the calls may be made at normal cost. Thus, in this embodiment, whatever option the user selects for the first telephone call remains in effect for subsequent telephone calls. In yet another embodiment, if the user does not select the reduced fee option upon initiating the first telephone call, then when the user initiates subsequent telephone calls, the reduced fee option may still be presented, giving the user the opportunity to use the reduced fee service for subsequent calls.

While the present invention has been described with reference to particular embodiments, it will be understood that the embodiments are illustrative and that the invention scope is not so limited. Any variations, modifications, additions, and improvements to the embodiments described are possible. These variations, modifications, additions, and improvements may fall within the scope of the inventions as detailed within the following claims.

What is claimed is:

1. A method for providing advertisements to a telephony device, the method comprising:
a user initiating a telephone connection to place a telephone call;
providing one or more advertisements to the telephony device for presentation to the user; and
the user placing the telephone call at a reduced cost in response to said providing one or more advertisements to the telephony device.

2. The method of claim 1, further comprising:
presenting an option message to the user after the user initiating the telephone connection to place the telephone call, wherein the option message provides the user with an option to listen to one or more advertisements for reduced telephone charging; and
receiving user input indicating the user's selection to listen to one or more advertisements for reduced telephone charging.

3. The method of claim 2, wherein said providing the one or more advertisements to the telephony device for presentation to the user is performed in response to receiving user input indicating the user's selection to listen to one or more advertisements for reduced telephone charging.

4. The method of claim 2, wherein if the user does not select the option to first listen to one or more advertisements, the telephone call is placed at normal cost.

5. The method of claim 1, further comprising:
presenting an option message to the user after the user initiating the telephone connection to place the telephone call, wherein the option message provides the user with an option to first listen to one or more advertisements, then place the telephone call at a reduced cost; and receiving user input indicating the user's selection to first listen to one or more advertisements, then place the telephone call at a reduced cost.

6. The method of claim 1, further comprising:
presenting an option message to the user after the user initiating the telephone connection to place the telephone call, wherein the option message provides the user with a choice between 1) the user placing the telephone call at a normal cost, and 2) the user first listening to one or more advertisements, then placing the telephone call at a reduced cost; and
receiving user input indicating the user's choice of either 1) placing the telephone call at a normal cost, or 2) first listening to one or more advertisements, then placing the telephone call at a reduced cost.
wherein said providing one or more advertisements is performed in response to receiving user input indicating the user's choice of (2).

7. The method of claim 1, wherein the user placing the telephone call at a reduced cost comprises the user placing the telephone call at no cost.

8. The method of claim 1,
wherein the telephone call comprises one of a local telephone call or a long-distance telephone call.

9. The method of claim 1,
wherein the providing one or more advertisements to the telephony device comprises providing one or more audio messages to the telephony device.

10. The method of claim 1,
wherein the providing one or more advertisements to the telephony device comprises providing one or more audiovisual messages to the telephony device.

11. The method of claim 1,
wherein the one or more advertisements include content based on a geographic location of the telephony device.

12. The method of claim 1,
wherein the one or more advertisements include content based on demographic information of the user of the telephony device.

13. A method for providing charge options to a user of a telephony device, the method comprising:
receiving input indicating a user initiation of a telephone connection to place a telephone call;
providing one or more charge options to the telephony device for presentation to the user, wherein said charge options include a reduced charge option contingent upon provision of one or more advertisements to the telephony device; and
receiving user input selecting the reduced charge option.

14. The method of claim 13, further comprising:
providing one or more advertisements to the telephony device in response to receiving user input selecting the reduced charge option; and
the user placing the telephone call at a reduced charge in response to said providing one or more advertisements to the telephony device.

15. The method of claim 14,
wherein the user placing the telephone call at a reduced charge comprises the user placing the telephone call at no charge.

16. The method of claim 13,
wherein the providing one or more advertisements to the telephony device comprises providing one or more audio messages to the telephony device.

17. A method for providing charge options to a user of a telephony device, the method comprising:
receiving input indicating a user initiation of a telephone connection to place a telephone call;
providing one or more charge options to the telephony device for presentation to the user, wherein said charge options include a first charge option for normal charging, wherein said charge options include a second reduced charge option contingent upon provision of one or more advertisements to the telephony device; and
receiving user input selecting one of the first charge option or the second reduced charge option.

18. The method of claim 17, further comprising:
providing one or more advertisements to the telephony device in response to receiving user input selecting the second reduced charge option; and
the user placing the telephone call at a reduced charge in response to said providing one or more advertisements to the telephony device.

19. A system for providing advertisements to a telephony device, the system comprising:
a PBX, wherein the PBX is communicatively coupled to the telephony device, and wherein the PBX is operable to provide telecommunication services to the telephony device;
an advertisement server, wherein the advertisement server is communicatively coupled to the PBX and the telephony device, wherein the advertisement server is configurable to provide one or more advertisements to the telephony device for presentation to a user of the telephony device;
wherein the telecommunication services are provided to the user at reduced charging in response to the advertisement server providing one or more advertisements to the telephony device.

20. The system of claim 19,
wherein the advertisement server is further configurable to present an option message to the user of the telephony device, wherein the option message provides the user with an option of listening to one or more advertisements for reduced costs of the telecommunication services; and
wherein the advertisement server is further configurable to receive user input after the provision of the option message to the user, wherein the user input indicates the user's selection of the option of listening to one or more advertisements for reduced costs of the telecommunication services.

21. The system of claim 20,
wherein the advertisement server is further configurable to provide one or more advertisements to the telephony device in response to receiving user input indicating the user's selection of the option to listen to one or more advertisements, then using the telecommunication services at a reduced cost.

22. The system of claim 19,
wherein the advertisement server is further configurable to present an option message to a user of the telephony device, wherein the option message provides the user with a choice between 1) the user using the telecommunication services at a normal cost, and 2) the user first listening to one or more advertisements and then using the telecommunication services at a reduced cost; and
wherein the advertisement server is further configurable to receive user input after the provision of the choice to the user, wherein the user input indicates the user's choice of 1) using the telecommunication services at a normal cost, or 2) the user first listening to one or more advertisements, then using the telecommunication services at a reduced cost.

23. The system of claim 22,
wherein the advertisement server is further configurable to provide one or more advertisements to the telephony device in response to receiving user input indicating the user's choice of (2).

24. The system of claim 19,
wherein the PBX provides telecommunication services to a hotel; and
wherein the telephony device is located in a room of the hotel.

25. The system of claim 19,
wherein the PBX provides telecommunication services to a wireless telephone network; and
wherein the telephony device comprises a wireless telephone.

26. The system of claim 19,
wherein the telephony device includes video capabilities, and
wherein the advertisements include video content.

27. The system of claim 19,
wherein the PBX implements the advertisement server.

28. A system for providing advertisements to a telephony device, the system comprising:
a processor;
an input for coupling to the telephony device, wherein the input is operable to receive information regarding a connection status of the telephony device;
a memory medium coupled to the processor, wherein the memory medium stores an advertisement management program which is configurable to manage the presentation of advertisements to a user of the telephony device, wherein the memory medium is also operable to store one or more advertisements for presentation to the user of the telephony device; and
an output for coupling to the telephony device, wherein the output is operable to send the one or more advertisements to the telephony device;
wherein the processor is operable to execute the advertisement management program to provided the one or more advertisements to the telephony device;
wherein the telephony device is operable to provide telecommunication services to the user; and
wherein the telecommunication services are provided to the user at reduced charging in response to providing one or more advertisements to the telephony device.

29. The system of claim 28,
wherein the processor is operable to execute the advertisement management program to send an option message to the telephony device, wherein the option message provides the user an option to first listen to one or more advertisements, then use the telecommunication services at a reduced cost; and
wherein the input is operable to receive the user's selection of the option to first listen to one or more advertisements, then use the telecommunication services at a reduced cost;

30. The system of claim 29,
wherein the advertisement management program is further configurable to provide the one or more advertisements to the telephony device in response to receiving user input indicating the user's selection of the option to first listen to one or more advertisements, then use the telecommunication services at a reduced cost.
